(19) United States
(12) Patent Application Publication
(10) Pub. No.: US 2021/0105716 A1
(43) Pub. Date: Apr. 8, 2021

(54) Design of Cross-Slot Scheduling Adaptation

(71) Applicant: MEDIATEK INC., Hsin-Chu (TW)

(72) Inventors: Wei-De Wu, Hsin-Chu (TW); Cheng-Hsun Li, Hsin-Chu (TW); Yi-Ju Liao, Hsin-Chu (TW); Pei-Kai Liao, Hsin-Chu (TW)

(21) Appl. No.: 17/012,939

(22) Filed: Sep. 4, 2020

Related U.S. Application Data
(60) Provisional application No. 62/910,682, filed on Oct. 4, 2019.
(60) Provisional application No. 62/916,322, filed on Oct. 17, 2019.
(60) Provisional application No. 62/933,072, filed on Nov. 8, 2019.

(51) Int. Cl. H04W 52/02; H04L 12/24; H04W 72/12; H04W 72/04

(52) U.S. Cl. CPC H04W 52/0216; H04L 41/0806; H04W 72/0446; H04L 41/0896; H04W 72/1289

(57) ABSTRACT

A method of dynamically adapt to a minimum applicable scheduling offset value for a UE operated with bandwidth part (BWP) and cross-slot scheduling in a mobile communication network is proposed. At higher layer (L2 RRC layer), the UE receives RRC configuration for a set of minimum applicable scheduling offset values (K0/K2) for downlink/uplink cross-slot scheduling. At lower layer (L1 physical layer), the UE dynamically determines an active minimum K0/K2 value for an active DL BWP or UL BWP based on 1) a one-bit DCI indicator over PDCCH; or based on 2) an active BWP change due to timeout.

### CROSS REFERENCE TO RELATED APPLICATIONS

This application claims priority under 35 U.S.C. § 119 from U.S. Provisional Application No. 62/910,682 entitled “Design of Cross-Slot Scheduling Adaptation,” filed on Oct. 4, 2019; U.S. Provisional Application No. 62/916,322, entitled “Cross-Slot Scheduling Adaptation,” filed on Oct. 17, 2019; U.S. Provisional Application No. 62/933,072 entitled “Design of Cross-Slot Scheduling Adaptation,” filed on Nov. 8, 2019, the subject matter of each of the foregoing documents is incorporated herein by reference.

### TECHNICAL FIELD

The disclosed embodiments relate to broadcast channel design, and more specifically, to Cross-Slot scheduling adaptation in next generation 5G new radio (NR) mobile communication networks.

### BACKGROUND

A Long-Term Evolution (LTE) system offers high peak data rates, low latency, improved system capacity, and low operating cost resulting from simple network architecture. An LTE system also provides seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred as user equipments (UEs). Enhancements to LTE systems are considered so that they can meet or exceed International Mobile Telecommunications Advanced (IMT-Advanced) fourth generation (4G) standard.

The signal bandwidth for next generation 5G new radio (NR) systems is estimated to increase to up to hundreds of MHz for below 6 GHz bands and even to values of GHz in case of millimeter wave bands. Furthermore, the NR peak rate requirement can be up to 20 Gbps, which is more than ten times of LTE. Three main applications in 5G NR system include enhanced Mobile Broadband (eMBB), Ultra-Reliable Low Latency Communications (URLLC), and massive Machine-Type Communication (MTC) under milli-meter wave technology, small cell access, and unlicensed spectrum transmission. Multiplexing of eMBB & URLLC within a carrier is also supported.

In LTE/NR networks, Physical Downlink Control Channel (PDCCH) is used for downlink (DL) scheduling or uplink (UL) scheduling of Physical Downlink Shared Channel (PDSCH) or Physical Uplink Shared Channel (PUSCH) transmission. Typically, PDCCH can be configured to occupy the first one, two, or three OFDM symbols in a subframe. The DL/UL scheduling information carried by PDCCH is referred to as downlink control information (DCI). The DCI format is a predefined format in which the downlink control information is formed and unicasted by a serving base station to each UE in PDCCH.

Each UE needs to monitor the PDCCH for possible data scheduling information, even during periods when data is not scheduled. For power-saving mechanism, the concept of cross-slot scheduling has been proposed. Under DL cross-slot scheduling, the network can inform UE that a guaranteed minimum time interval of K0 slots exists between the PDCCH and the DL data packet it schedules. Similarly, under UL cross-slot scheduling, the network can inform UE that a guaranteed minimum time interval of K2 slots exists between the PDCCH and the UL data packet it schedules. The UE can thereby omit unnecessary radio frequency (RF) operation if no DL/UL data is scheduled. The UE may also be able to use a more efficient receiver configuration for PDCCH reception.

To save power, NR further introduces the concept of bandwidth part (BWP), which consist of a continuous range of physical resource blocks (PRBs) in frequency domain and whose occupied bandwidth is a subset of the bandwidth of the associated carrier. UE can be configured by the network with several UL BWPs and DL BWPs, and UE is required to monitor at most one uplink BWP and downlink BWP at the same time. The downlink BWP and uplink BWP which is being used or monitored by the UE is called active BWP, e.g. active DL BWP and active UL BWP respectively. For each active DL BWP and each active UL BWP, it can have a minimum applicable value of K0/K2 (hereinafter also referred to as minimum K0/K2) for the purpose of cross-slot scheduling.

A solution is sought for UE to dynamically adapt the minimum K0/K2 in NR wireless communication systems.

### SUMMARY

A method of dynamically adapt to a minimum applicable scheduling offset value for a UE operated with bandwidth part (BWP) and cross-slot scheduling in a mobile communication network is proposed. At higher layer (L2 RRC layer), the UE receives RRC configuration for a set of minimum applicable scheduling offset values (K0/K2) for downlink/uplink cross-slot scheduling. At lower layer (L1physical layer), the UE dynamically determines an active minimum K0/K2 value for an active DL BWP or UL BWP based on 1) a one-bit DCI indicator over PDCCH; or based on 2) an active BWP change due to timeout. In one embodiment, the UE provides assistance information to the network, which comprises a set of UE-preferred minimum applicable scheduling offset values for different numerologies/subcarrier spacing (SCS) values.

In one embodiment, a UE receives a radio resource control (RRC) configuration from a base station in a mobile communication network. The RRC configuration comprises one or more RRC-configured minimum applicable scheduling offset values for cross-slot scheduling. The UE decodes downlink control information (DCI) provided from the base station when the UE receives the DCI over a physical downlink control channel (PDCCH). The DCI comprises a minimum applicable scheduling offset indicator for an active bandwidth part (BWP). The UE determines the minimum applicable scheduling offset value for the active BWP based on a joint determination from the one or more RRC-configured minimum applicable scheduling offset values and the minimum applicable scheduling offset indicator. In one example, the minimum applicable scheduling offset indicator is a 1-bit indicator—a value “0” indicating a first RRC-configured minimum applicable scheduling offset value; and a value “1” indicating a second RRC-configured minimum applicable scheduling offset value, or indicating the minimum applicable scheduling offset value to be zero (e.g., no restriction on the minimum applicable scheduling offset value) if there is no second RRC-configured minimum applicable scheduling offset value.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a next generation new radio (NR) mobile communication network with cross-slot scheduling adaptation for power saving in accordance with one novel aspect.

FIG. 2 illustrates simplified block diagrams of a base station and a user equipment in accordance with embodiments of the present invention.

FIG. 3 illustrates an example of downlink cross-slot scheduling and UE power saving in accordance with one novel aspect.

FIG. 4 illustrates a procedure of L1-based adaptation for cross-slot scheduling in accordance with embodiments of the present invention.

FIG. 5 illustrates one embodiment of joint indication of cross-slot scheduling for active downlink and uplink bandwidth part (BWP) in accordance with embodiments of the present invention.

FIG. 6 illustrates examples of RRC configured parameters for cross-slot scheduling in accordance with embodiments of the present invention.

FIG. 7 is a flow chart of a method of cross-slot scheduling adaptation from UE perspective in accordance with one novel aspect.

### DETAILED DESCRIPTION

Reference will now be made in detail to some embodiments of the invention, examples of which are illustrated in the accompanying drawings.

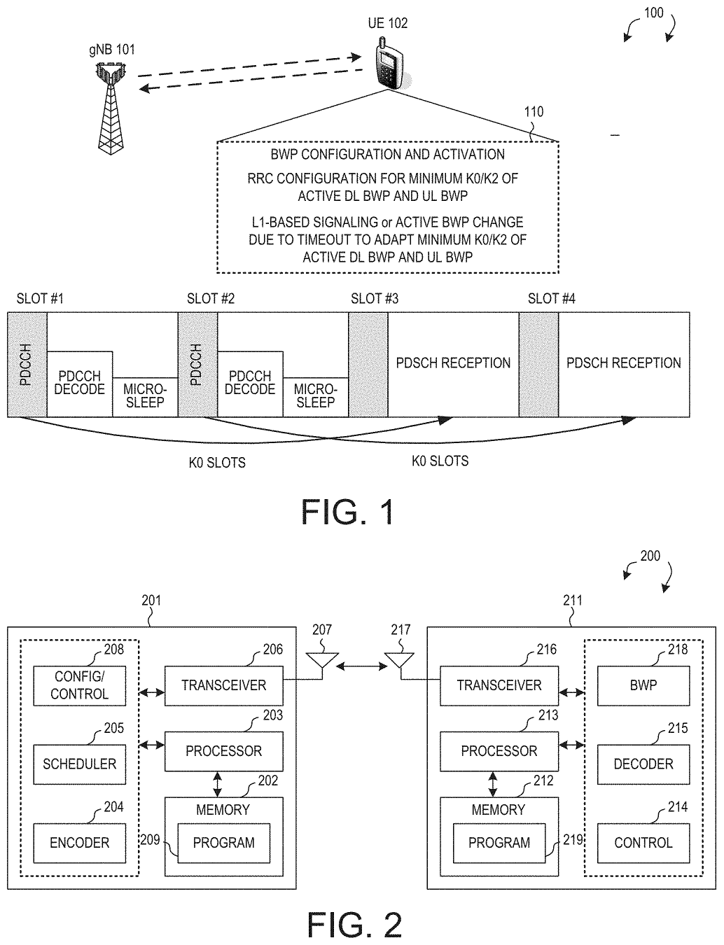

FIG. 1 illustrates a next generation new radio (NR) mobile communication network 100 with cross-slot scheduling adaptation for power saving in accordance with one novel aspect. Mobile communication network 100 is an OFDM/OFDMA system comprising a base station gNB 101 and a plurality of user equipments including UE 102. When there is a downlink packet to be sent from the BS to a UE, the UE gets a downlink assignment, e.g., a set of radio resources in a physical downlink shared channel (PDSCH). When a UE needs to send a packet to the BS in the uplink, the UE gets a grant from the BS that assigns a physical uplink shared channel (PUSCH) consisting of a set of uplink radio resources. The UE gets the downlink or uplink scheduling information from a Physical downlink control channel (PDCCH) that is targeted specifically to the UE. In addition, broadcast control information is also sent in the PDCCH to all UEs in a cell. The downlink and uplink scheduling information and the broadcast control information, carried by the PDCCH, together is referred to as downlink control information (DCI).

In 3GPP LTE system based on OFDMA downlink, the radio resource is partitioned into radio frames and subframes, each subframe is comprised of two slots and each slot has seven OFDMA symbols along time domain. Each OFDMA symbol further consists of a number of OFDMA subcarriers along frequency domain depending on the system bandwidth. The basic unit of the resource grid is called Resource Element (RE), which spans an OFDMA subcarrier over one OFDMA symbol. Comparing to LTE numerology (subcarrier spacing and symbol length), in next generation 5G NR systems, multiple numerologies are supported and the radio frame structure gets a little bit different depending on the type of numerology. For example, multiple numerologies with 15 KHz subcarrier spacing and its integer or 2^{m} multiple are proposed, where m is a positive integer. The supported subcarrier spacing can be 15 KHz, 30 KHz, 60 KHz, 120 KHz, and 240 KHz. However, regardless of numerology, the length of one radio frame is always 10 ms, and the length of a subframe/slot is always 1 ms.

Each UE needs to monitor the PDCCH for possible data scheduling information, even during periods when data is not scheduled. For power-saving mechanism, the concept of cross-slot scheduling has been proposed. Under DL cross-slot scheduling, the network can inform UE that a guaranteed minimum time interval of K0 slots exists between the PDCCH and the DL data packet it schedules. Similarly, under UL cross-slot scheduling, the network can inform UE that a guaranteed minimum time interval of K2 slots exists between the PDCCH and the UL data packet it schedules. The UE can thereby omit unnecessary radio frequency (RF) operation if no DL/UL data is scheduled. The UE may also be able to use a more efficient receiver configuration for PDCCH reception. As illustrated in FIG. 1, UE 102 receives PDCCH for DL scheduling in slot #1, and may perform PSDCH reception in slot #3 when K0=2. Similarly, UE 102 receives PDCCH in slot #2, and may perform PSDCH reception in slot #4 when K0=2. Note that the value of K0/K2 represents the actual applicable scheduling offset value for downlink and uplink, respectively. On the other hand, the minimum applicable value of K0/K2 (hereinafter also referred to as minimum K0/K2) represents the minimum applicable scheduling offset value for downlink and uplink, respectively. For example, if minK0 is equal to 2, but K0 is set to 3 in DCI (i.e., K0 is set to any value that is at least equal to minK0), then PDSCH is scheduled in slot # N+3 by PDCCH in slot N.

To save power, NR further introduces the concept of bandwidth part (BWP), which consist of a continuous range of physical resource blocks (PRBs) in frequency domain and whose occupied bandwidth is the subset of the bandwidth of the associated carrier. Under BWP operation, a UE can be configured by the network with several downlink BWPs and uplink BWPs. To save power consumption, the UE is required to monitor at most one uplink BWP and downlink BWP at the same time. The downlink BWP and uplink BWP which is being used or monitored by the UE is called active BWP, e.g. active DL BWP and active UL BWP respectively. For an active DL BWP and an active UL BWP, the UE can first be configured with the minimum K0/K2 by the network via RRC signaling, e.g., up to two configured values., and then the UE can dynamically adapt the minimum K0/K2 as indicated by the network via DCI over PDCCH.

In accordance with one novel aspect, a method of dynamically adapt to a minimum applicable scheduling offset value (a minimum K0/K2 value) for an active BWP of a UE operated with cross-slot scheduling is proposed. In the example of FIG. 1 (110), UE 102 is configured by gNB 101 with several DL BWPs and UL BWPs, with one active DL BWP and one active UL BWP. UE 102 is operated with cross-slot scheduling for power saving. At higher layer (L2 RRC layer), UE 102 receives RRC configuration for a set of minimum applicable K0 values for DL cross-slot scheduling, and a set of minimum applicable K2 values for UL cross-slot scheduling. At lower layer (L1 physical layer), UE 102 dynamically determines an active minimum K0 or K2 value for an active DL BWP or UL BWP based on 1) a one-bit DCI indicator over PDCCH or based on 2) an active BWP change due to timeout. If the dynamic adaptation is based on a one-bit DCI indicator, then an indicator of “0” indicates a first RRC-configured minimum K0/K2 value, while an indicator of “1” indicates a second RRC-configured minimum K0/K2 value, or indicates a minimum K0/K2 value of 0 (e.g., no restriction on the scheduling offset) if only one RRC-configured minimum K0/K2 value. Note that the above DCI indicator is used for an active DL/UL BWP, such that the UE can dynamically adapt to a different minimum K0/K2 for the current active DL/UL BWP based on the DCI indicator without BWP switching. On the other hand, if the dynamic adaptation is based on an active BWP change due to timeout, then the active minimum K0/K2 is equal to the first RRC-configured minimum K0/K2 value.

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similarly, for UE 211, antenna 217 transmits and receives radio signals. RF transceiver module 216, coupled with the antenna, receives RF signals from the antenna, converts them to baseband signals and sends them to processor 213. RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules and circuits to carry out some embodiments of the present invention. The different functional modules and circuits can be implemented by software, firmware, hardware, or any combination thereof. In one example, each function module or circuit comprises a processor together with corresponding program codes. The function modules and circuits, when executed by the processors 203 and 213 (e.g., via executing program codes 209 and 219), for example, allow base station 201 to configure BWPs and cross-slot scheduling for UE 211, transmit RRC-configured minimum K0/K2 and minimum applicable scheduling offset indicator over PDCCH to UE 211, and allow UE 211 to receive RRC signaling and decode PDCCH for adaptively determine the minimum K0/K2 for an active DL/UL BWP accordingly.

In one embodiment, base station 201 configures BWP and cross-slot scheduling operation for UE 211 via config/control circuit 208 and schedules downlink reception and uplink transmission over PDCCH for UE 211 via scheduler 205. The configuration signaling and scheduling are then modulated and encoded via encoder 204 to be transmitted by transceiver 206 via antenna 207. UE 211 receives the configuration and scheduling information by transceiver 216 via antenna 217. UE 211 operates under BWP via BWP module 218, decodes the PDCCH via decoder 215, and determines the active minimum applicable scheduling offset value via control module 214. In one example, UE 211 dynamically determines an active minimum applicable scheduling offset value for an active DL BWP or UL BWP based on 1) a one-bit DCI indicator over PDCCH or based on 2) an active BWP change due to timeout.

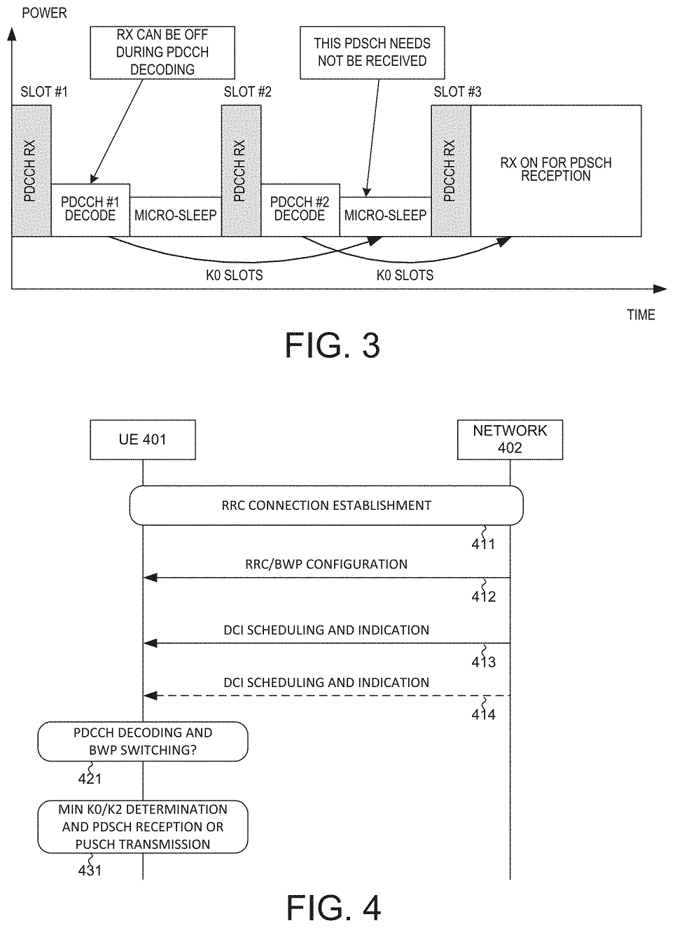

FIG. 3 illustrates an example of downlink cross-slot scheduling and UE power saving in accordance with one novel aspect. In traditional same-slot scheduling, the control information (PDCCH) and data information (PDSCH) are scheduled in the same slot. A UE is configured to monitor and receive the PDCCH. After receiving the PDCCH, the UE needs processing time to decode the PDCCH. Since the UE assumes that there may be downlink data in the slot, the UE keeps the RF transceiver on to receive and store all OFDM symbols over the time to receive and decode PDCCH. After determining that there is no downlink data for the UE in the slot, the UE may turn off its RF transceiver. However, in an event that there is no downlink data for the UE scheduled in the same slot, the UE may waste power to monitor the same-slot scheduling in every slot. If the UE knows that there will not be any PDSCH, the UE may be able to turn off its RF receiver after the reception of the PDCCH and reduce power consumption.

In cross-slot scheduling, the concept of a minimum interval of K0 slot for downlink scheduling and a minimum interval of K2 slot for uplink scheduling is introduced and configured by the network. The network can inform UE that a guaranteed minimum time interval of K0/K2 slots exists between the PDCCH and the DL/UL data packet it schedules, respectively. Using downlink cross-slot scheduling as an example, the minimum time interval is K0 slot between the scheduling DCI over PDCCH and the scheduled DL data over PDSCH. In other words, if PDCCH is received in slot n, then UE will receive DL data over PDSCH no earlier than in slot n+K0. For example, if K0=1, in slot #1, UE turns its RX on to receive PDCCH, and UE will receive PDSCH in slot #2 or later. Since UE knows that there are no PDSCH in slot #1, the RX can be turned off while performing PDCCH #1 decoding. After PDCCH #1 decoding, UE can go to micro-sleep until next slot to save more power. Based on PDCCH #1 decoding, assume that there is no PDSCH being scheduled for the UE in slot #2. In slot #2, UE turns its RX on to receive PDCCH #2. Since UE knows that there are no PDSCH in slot #2, the RX can be turned off while performing PDCCH decoding. After PDCCH #2 decoding, UE knows that PDSCH is scheduled for the UE in slot #3. UE can go to micro-sleep until slot #3 to save more power. In slot #3, UE turns its RX on to receive PDCCH and continued its RX on to receive the scheduled downlink data over PDSCH, which is scheduled by PDCCH #2. As compared to same-slot scheduling, it can be seen that the UE can save power consumption during PDCCH decoding and can go to micro-sleep when there is no scheduled downlink data over PDSCH. Here, “micro-sleep” is an intermediate low-power state in DRX active mode as compared to a “deep sleep” for a lowest power state in DRX inactive mode. It means that UE can save power in DRX active mode without active operation.

The minimum applicable scheduling offset indicator for minimum K0/K2 adaptation in cross-slot scheduling is carried by a DCI, which is a scheduling DCI and thus can only be sent by the network during DRX active time. However, during data inactivity time, there is no data scheduling. It remains open how to indicate UE to apply cross-slot scheduling for power saving during data inactivity. When the DCI indicator for minimum K0/K2 adaptation is carried in the scheduling DCI of the last transport block (TB), there is potential TB NACK event. Then the base station will need to schedule retransmissions with cross-slot scheduling, which then impacts the data scheduler design assuming same-slot scheduling. If this issue is not resolved, cross-slot scheduling may not be used in DRX ON durations with data scheduling. To avoid entering cross-slot scheduling when the last TB of a data burst is NACK, one solution is to allow entering cross-slot scheduling only after UE successfully decodes the last TB that contains the scheduling DCI, which in turn carries the DCI indicator of minimum K0/K2 for cross-slot scheduling. That is, when UE is indicated changing to a larger minimum applicable K0/K2 value by DCI during active time, UE applies the target minimum K0/K2 value only after the UE successfully decodes the scheduled TB by the DCI, subject to a proper application delay.

FIG. 4 illustrates a procedure of L1-based adaptation for cross-slot scheduling in accordance with embodiments of the present invention. In step 411, UE 401 and network 402 establishes a radio resource control RRC connection. UE 401 may enter discontinuous reception (DRX) mode for power saving. In step 412, network 402 configures UE 401 with cross-slot operation and provides RRC configuration parameters to UE 401. The RRC configuration parameters may include a set of minimum applicable K0/K2 values. Network 402 may also configure UE 401 with BWP operation and provide BWP parameters including one active DL BWP and one active UL BWP. In step 413, network 402 sends DCI to UE 401 for DL/UL scheduling over PDCCH. The DCI may include a one-bit indicator for adapting the minimum K0/K2 values of the activated DL/UL BWP. In step 421, UE 401 performs PDCCH decoding to obtain scheduling information and the one-bit indicator. UE 401 also detects whether the activated BWP has been switched to a different BWP due to timeout without triggered by DCI. In step 431, UE 401 determines the minimum applicable K0/K2 value based on the decoded DCI indicator or based on active BWP switching. If there is no PDSCH/PUSCH for the current slot, then UE 401 can go to micro-sleep to save power. Otherwise, UE 401 performs PDSCH reception or PUSCH transmission accordingly.

Note that UE is not expected to receive a different value in the one-bit indicator before the previous indicated minimum K0/K2 value is applied. Specifically, when the UE is scheduled by DCI with a minimum applicable scheduling offset indicator field, it shall determine the minimum K0/K2 values to be applied, while the previously applied minimum K0/K2 values are applied until the new values take effect after application delay of X (slot(s)) of the scheduling cell. Change of applied minimum applicable scheduling offset indication carried by DCI in slot n, shall be applied in slot n+X of the scheduling cell. UE does not expect to be scheduled with DCI that indicates another change to the applied minimum K0/K2 values for the same active BWP before slot n+X of the scheduling cell. For example, in step 414, network 402 may send a second DCI to UE 401 for DL/UL scheduling over PDCCH. The second DCI may include another one-bit indicator for adapting the minimum applicable value of K0/K2 for the same activated DL/UL BWP. If the second DCI occurs before the previous determined minimum applicable K0/K2 value is applied, then UE 401 may ignore the second DCI indicator.

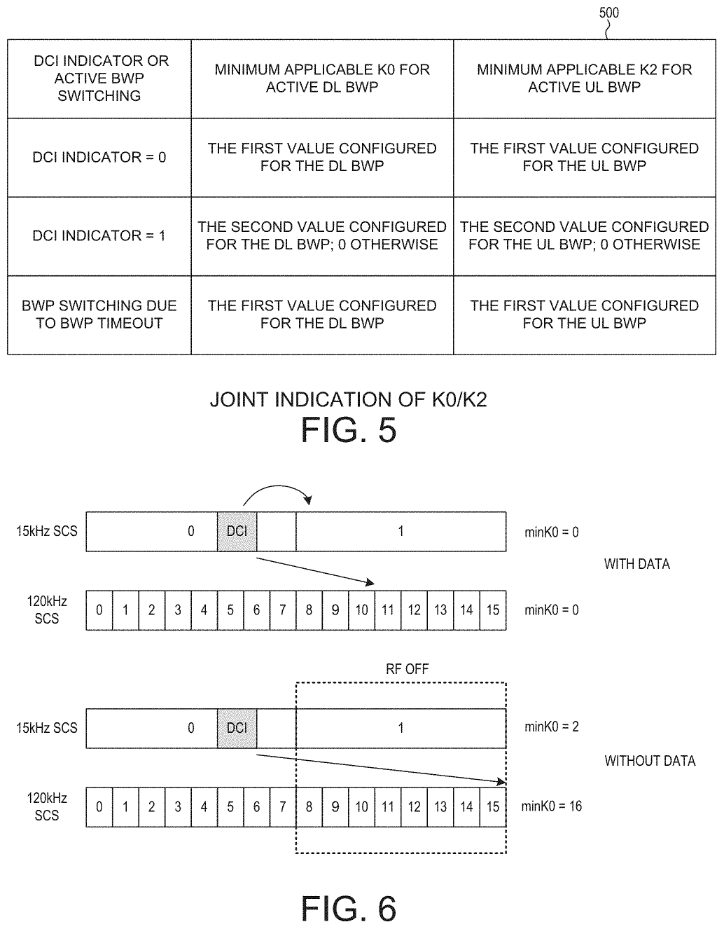

FIG. 5 illustrates one embodiment of joint indication of cross-slot scheduling for active downlink and uplink bandwidth part (BWP) in accordance with embodiments of the present invention. The determination of the minimum applicable scheduling offset value of an active DL/UL BWP involves three steps: a first step of receiving RRC configuration parameters for a set of minimum applicable scheduling offset values; a second step of receiving a dynamic indication carried by DCI or detecting an active BWP switching due to timeout; and a third step of final adaptation. In one example, the set of RRC-configured minimum applicable K0/K2 values may include only one configured value. In another example, the set of RRC-configured minimum applicable K0/K2 values may include two configured values (e.g., a first value with lower-indexed RRC-configured value, and a second value with higher-indexed RRC-configured value).

As depicted by Table 500 of FIG. 5, for an active DL (UL) BWP with only one RRC-configured minimum applicable K0 (K2) value, value 0 of the 1-bit DCI indicator for cross-slot scheduling adaptation indicates the configured value, and value 1 of the 1-bit indicator indicates no restriction (e.g., K0/K2=0). For an active DL (UL) BWP with two RRC-configured minimum applicable K0/K2 value, value 0 of the 1-bit DCI indicator for cross-slot scheduling adaptation indicates the configured value, and value 1 of the 1-bit indicator indicates no restriction. In other senarios, the minimum applicable K0/K2 value may need to be adapted when the active DL/Ul BWP is changed even without receiving the 1-bit inidcator carried by DCI, e.g., due to BWP switching triggered by BWP timer expiration. For adapting the minimum applicable value of K0/K2 for the active BWP, when there are one or two RRC-configured values, the value applied for the active BWP is determined by: the configured value if one value is RRC configured; the lowest-indexed RRC configured value if two values are RRC configured.

FIG. 6 illustrates examples of RRC-configured parameters for cross-slot scheduling in accordance with embodiments of the present invention. The RRC-configured minimum K0/K2 values are a subset of all the possible values of the existing minimum K0/K2 parameters. In next generation 5G NR systems, multiple numerologies are supported and the radio frame structure gets a little bit different depending on the type of numerology. For example, multiple numerologies with 15 KHz subcarrier spacing and its integer or 2^{m} multiple are proposed, where m is a positive integer. The supported subcarrier spacing (SCS) can be 15 KHz, 30 KHz, 60 KHz, 120 KHz, and 240 KHz. As a result, in order for covering the cross-carrier scheduling with different numerology, for RRC configuration, the configured minimum applicable K0/K2 values take integer values in the range from 0 to 16. This is because in order to allow the same RF off duration across the carriers of different SCS, the minK0 value, defined for each scheduled carrier, should be aligned. In the example of FIG. 6, a primary PCell of 15k SCS applies minK0=2 and a secondary SCell of 120k SCS should apply minK0=16, which contributes to the maximum configurable number for the minimum applicable scheduling offsets.

In one novel aspect, UE can suggest to the network a preferred set of minimum applicable values for K0/K2 for different numerologies. The RRC-based UE signaling of suggested set of minimum applicable values for K0/K2 for applying cross-slot scheduling can be provided to the network as UE assistance information, and should cover all possible numerology/SCS cases. Each suggested value is in the range from 1 to 4 or 8 slots, assuming same-carrier scheduling. For the case of cross-slot scheduling, it is beneficial for UE power saving to align the configured minimum applicable K0/K2 values of the scheduling cell and those of the scheduled cell for cross-slot scheduling. Based on the UE suggested minimum applicable values for K0/K2, the network can then determine the RRC-configured parameters.

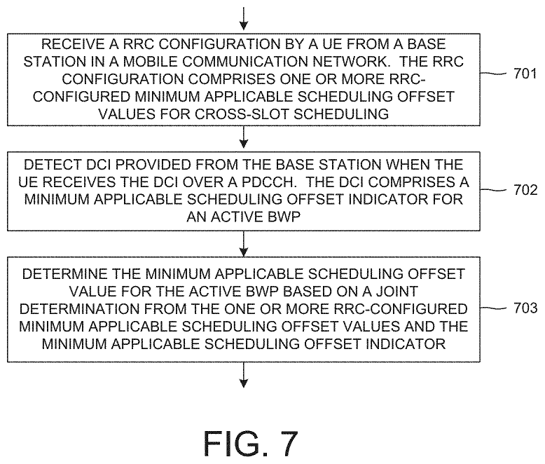

FIG. 7 is a flow chart of a method of cross-slot scheduling adaptation from UE perspective in accordance with one novel aspect. In step 701, a UE receives a radio resource control (RRC) configuration from a base station in a mobile communication network. The RRC configuration comprises one or more RRC-configured minimum applicable scheduling offset values for cross-slot scheduling. In step 702, the UE decodes downlink control information (DCI) provided from the base station when the UE receives the DCI over a physical downlink control channel (PDCCH). The DCI comprises a minimum applicable scheduling offset indicator for an active bandwidth part (BWP). In step 703, the UE determines the minimum applicable scheduling offset value for the active BWP based on a joint determination from the one or more RRC-configured minimum applicable scheduling offset values and the minimum applicable scheduling offset indicator.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a radio resource control (RRC) configuration by a user equipment (UE) from a base station in a mobile communication network, wherein the RRC configuration comprises one or more RRC-configured minimum applicable scheduling offset values for cross-slot scheduling;
decoding downlink control information (DCI) provided from the base station when the UE receives the DCI over a physical downlink control channel (PDCCH), wherein the DCI comprises a minimum applicable scheduling offset indicator for an active bandwidth part (BWP); and
determining the minimum applicable scheduling offset value for the active BWP based on a joint determination from the one or more RRC-configured minimum applicable scheduling offset values and the minimum applicable scheduling offset indicator.

2. The method of claim 1, wherein each minimum applicable scheduling offset value is represented by a number of slots between a scheduling slot and a scheduled slot for downlink cross-slot scheduling, or by a number of slots between a scheduling slot and a scheduled slot for uplink cross-slot scheduling.

3. The method of claim 2, wherein the minimum applicable scheduling offset value is equal to a first RRC-configured value if the indicator is set to “0”, and equal to a second RRC-configured value or equal to 0 if not RRC-configured if the indicator is set to “1”.

4. The method of claim 1, wherein the RRC-configured minimum applicable scheduling offset values are subject to a range from 0 to 16 for different numerology.

5. The method of claim 1, further comprising:
transmitting UE assistance information to the base station, wherein the UE assistance information comprises a set of UE-preferred minimum applicable scheduling offset values for different numerologies.

6. The method of claim 1, wherein the UE receives a second DCI having a second indicator before the UE applies the determined offset value, and wherein the UE ignores the second indicator.

7. The method of claim 1, wherein the UE applies the minimum applicable scheduling offset value only when a scheduled transport block (TB) is correctly decoded.

9. The method of claim 1, further comprising:
determining the minimum applicable scheduling offset value for the active BWP upon detecting an active BWP change due to timeout.

10. The method of claim 9, wherein the minimum applicable scheduling offset value is determined to be equal to a first RRC-configured minimum applicable scheduling offset value.

11. A User Equipment (UE), comprising:
a receiver that receives a radio resource control (RRC) configuration from a base station in a mobile communication network, wherein the RRC configuration comprises one or more RRC-configured minimum applicable scheduling offset values for cross-slot scheduling;
a decoder that decodes downlink control information (DCI) provided from the base station when the UE receives the DCI over a physical downlink control channel (PDCCH), wherein the DCI comprises a minimum applicable scheduling offset indicator for an active bandwidth part (BWP); and
a scheduling handler that determines the minimum applicable scheduling offset value for the active BWP based on a joint determination from the one or more RRC-configured minimum applicable scheduling offset values and the minimum applicable scheduling offset indicator.

12. The UE of claim 11, wherein each minimum applicable scheduling offset value is represented by a number of slots between a scheduling slot and a scheduled slot for downlink cross-slot scheduling, or by a number of slots between a scheduling slot and a scheduled slot for uplink cross-slot scheduling.

13. The UE of claim 12, wherein the minimum applicable scheduling offset value is equal to a first RRC-configured value if the indicator is set to “0”, and equal to a second RRC-configured value or equal to 0 if not RRC-configured if the indicator is set to “1”.

14. The UE of claim 1, wherein the RRC-configured minimum applicable scheduling offset values are subject to a range from 0 to 16 for different numerologies.

15. The UE of claim 1, further comprising:
a transmitter that transmits UE assistance information to the base station, wherein the UE assistance information comprises a set of UE-preferred minimum applicable scheduling offset values for different numerologies.

16. The UE of claim 11, wherein the UE receives a second DCI having a second indicator before the UE applies the determined offset value, and wherein the UE ignores the second indicator.

17. The UE of claim 11, wherein the UE applies the minimum applicable scheduling offset value only when a scheduled transport block (TB) is correctly decoded.

19. The UE of claim 1, wherein the UE determines the minimum applicable scheduling offset value for the active BWP upon detecting an active BWP change due to timeout.

20. The UE of claim 19, wherein the minimum applicable scheduling offset value is determined to be equal to a first RRC-configured minimum applicable scheduling offset value.
